(19) United States
(12) Patent Application Publication
(10) Pub. No.: US 2026/0009921 A1
(43) Pub. Date: Jan. 8, 2026

(54) ACQUISITION CONSTRAINED COMPRESSIVE SENSING DESIGN FOR OCEAN BOTTOM NODE SURVEYS

(71) Applicant: SCHLUMBERGER TECHNOLOGY CORPORATION, Sugar Land, TX (US)

(72) Inventors: Rajiv KUMAR, Crawley (GB); David Fraser HALLIDAY, Crawley (GB); Massimiliano VASSALLO, Crawley (GB)

(21) Appl. No.: 19/127,751

(22) PCT Filed: Dec. 20, 2023
(86) PCT No.: PCT/US2023/085056

§ 371 Date: May 7, 2025

Related U.S. Application Data
(60) Provisional application No. 63/477,607, filed on Dec. 29, 2022.

(51) Int. Cl. G01V 1/38; G01V 1/30; G01V 1/32

(52) U.S. Cl. CPC G01V 1/3808; G01V 1/30; G01V 1/32

(57) ABSTRACT

A method for designing a seismic survey including (a) selecting a seismic survey grid as a basis for a seismic survey design, (b) generating off-the-grid locations by imposing spatial/temporal constraints on on-the-grid locations of the seismic survey grid, (c) mapping the off-the-grid locations from a physical domain to a pre-selected domain by applying a multidimensional transform to the off-the-grid locations, (d) mapping the pre-selected domain to a rank-revealing domain using a pre-selected operator, (e) applying a pre-selected process to minimize a rank of the off-the-grid locations in the pre-selected domain, (f) updating the seismic survey design based on which of the off-the-grid locations has the minimum rank, (g) repeating steps (b)-(f) for a number of iterations until a pre-selected threshold is met indicating an optimal seismic survey design, and (h) acquiring seismic data using the optimal seismic survey design.

### CROSS-REFERENCE TO RELATED APPLICATIONS

This application claims priority to U.S. Provisional Patent Application No. 63/477,607, filed on Dec. 29, 2022, which is incorporated by reference herein.

### BACKGROUND

Compressive sensing (CS) acquisition design is gaining momentum in the seismic industry. CS helps to acquire data with much denser sampling and higher unaliased bandwidth at the same acquisition cost as conventional surveys. Although CS-based random sampling design is quite successful, implementing it for seismic data acquisition is quite challenging because the acquisition is constrained by the movement of sources and receivers in the field for marine and ocean bottom node (OBN) surveys.

### SUMMARY

The system and method of the present disclosure include a compressive sensing-based acquisition design. Embodiments in accordance with the present disclosure enable movement of vessels in various patterns such as, for example, but not limited to, sinusoidal arcs. Such movement introduces randomness in designs that can be used in OBN acquisition to acquire data in CS way. The design enables simultaneous source data acquisition in which interference to a source from other sources is randomized.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for designing a seismic survey. The method includes (a) selecting a seismic survey grid as a basis for a seismic survey design. The method also includes (b) generating off-the-grid locations by imposing spatial or temporal constraints on on-the-grid locations of the seismic survey grid, where the spatial or temporal constraints include a range of pre-selected offsets from the on-the-grid locations. The off-the-grid locations are configured to collect OBN sparse data. The method also includes where a first constraint ensures that the off-the-grid locations maintain a desired sub-sampling ratio, and a second constraint is a spatial sub-sampling parameter. The method also includes where the spatial sub-sampling parameter is a jittered sampling parameter to control a gap size between source-receiver locations, and/or the spatial sub-sampling parameter is a first characteristic of a pre-selected survey pattern that incorporates crossline movement of vessels by a first pre-selected amount from the seismic survey grid. The first characteristic is an amplitude of a sine wave pattern, and/or the spatial sub-sampling parameter is a second characteristic of the pre-selected survey pattern that incorporates inline movement of the vessel by a second pre-selected amount from the seismic survey grid. The second characteristic is a phase of the sine wave pattern. The spatial sampling parameter is an overlap factor that controls if crosslines of the seismic survey overlap with each other or not during data acquisition. The method also includes (c) mapping the off-the-grid locations from a physical domain to a pre-selected domain by applying a multidimensional transform to the off-the-grid locations. The pre-selected domain is a wavenumber domain or a sparsity promoting domain. The multidimensional transform is a Fourier transform when the pre-selected domain is the wavenumber domain. The method also includes (d) mapping the pre-selected domain to a rank-revealing domain using a pre-selected operator. The method also includes (e) applying a pre-selected process to minimize a rank of the off-the-grid locations in the pre-selected domain. The pre-selected process includes (1) computing first and second singular values from the rank-revealing domain, and (2) estimating a spectral ratio as a ratio of the first and second singular values. The method also includes (f) updating the seismic survey design based on which of the off-the-grid locations has the minimum rank. The method also includes (g) repeating steps (b)-(f) for a number of iterations until a pre-selected threshold is met indicating an optimal seismic survey design. The number of iterations is based on a heuristic process. The method also includes (h) acquiring seismic data using the optimal seismic survey design. The seismic data are acquired from a regular or irregular grid with random time or space dithers. The regular or irregular grid has a seismic source. Multiple seismic sources are activated in activation patterns that are extended to more than two of the seismic sources. The seismic sources are deployed in a marine environment as single seismic sources or multiple seismic sources from single vessel-or multiple vessel-configurations for marine environments, and used to acquire the seismic data. The rank minimization is constrained by ensuring that two of the seismic sources are not activated within a pre-selected distance from each other by using spatial location constraints. The optimal seismic survey design includes regular or irregular grid locations with time dithers using an optimization scheme for both of the seismic sources and seismic receivers in a pre-selected number of directions. The seismic receivers are deployed in water along towed streamers or within waterbottom nodes. The seismic receivers can be geophones deployed on land. The seismic receivers can be deployed in wells, and the seismic data the seismic receivers are obtained through distributed acoustic sensors using fiber optic cables. The seismic sources are activated together or separated in time along with random and/or periodic time dithers with respect to each other. The optimal seismic survey design enables acquiring simultaneous and sequential seismic data. The spatial or temporal constraints for a source activation process include a quiet time between source activations. The quiet time includes setting a cap on a minimum or maximum randomized time interval between consecutive shots. The seismic data include measurements of one or more of pressure, particle velocity, displacement, or acceleration wavefields or any subset of these. The method also includes (j) enabling processing and displaying the seismic data from the seismic survey. The method also includes (k) enabling performing a wellsite action based at least on the seismic data. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A-1E, 2, 3A, and 3B illustrate simplified, schematic views of an oilfield and its operation, according to an embodiment.

FIGS. 4A-H illustrate different subsampling scenarios for an OBN survey.

FIGS. 5A-C illustrate the effect of different subsampling scenarios on the frequency-wavenumber spectrum, according to an embodiment.

FIGS. 6A-C illustrate a common receiver gather extracted from a geologically complex Society of Exploration Geophysicists (SEG) Advanced Modeling (SEAM) Corporation model, according to an embodiment.

FIGS. 7A-D illustrate reconstruction results using different sampling designs, and a comparison of the results, according to an embodiment.

FIGS. 8A-8J illustrate various seismic survey patterns in accordance with embodiments of the present disclosure.

FIGS. 9A and 9B are flowcharts of a method in accordance with embodiments of the present disclosure.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of embodiments of the invention. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of embodiments of the invention. The first object and the second object are both objects, respectively, but they are not to be considered the same object.

The terminology used in herein is for the purpose of describing particular embodiments only and is not intended to be limiting of embodiments of the invention. As used in herein and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

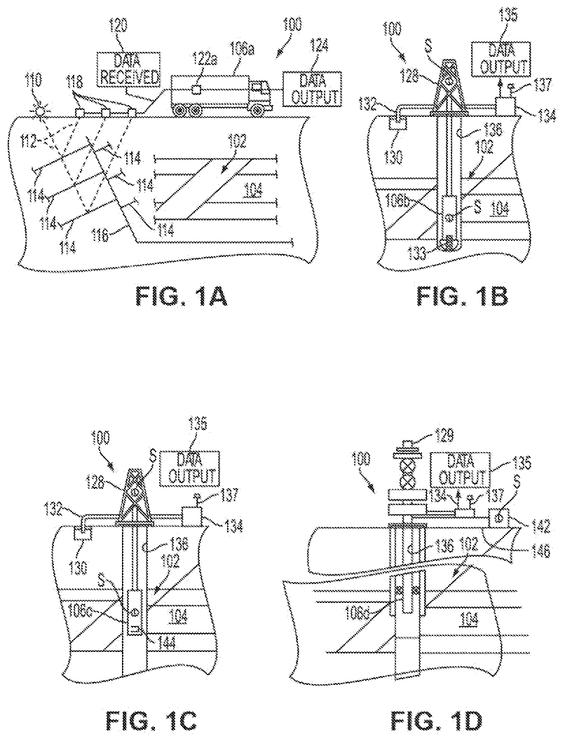

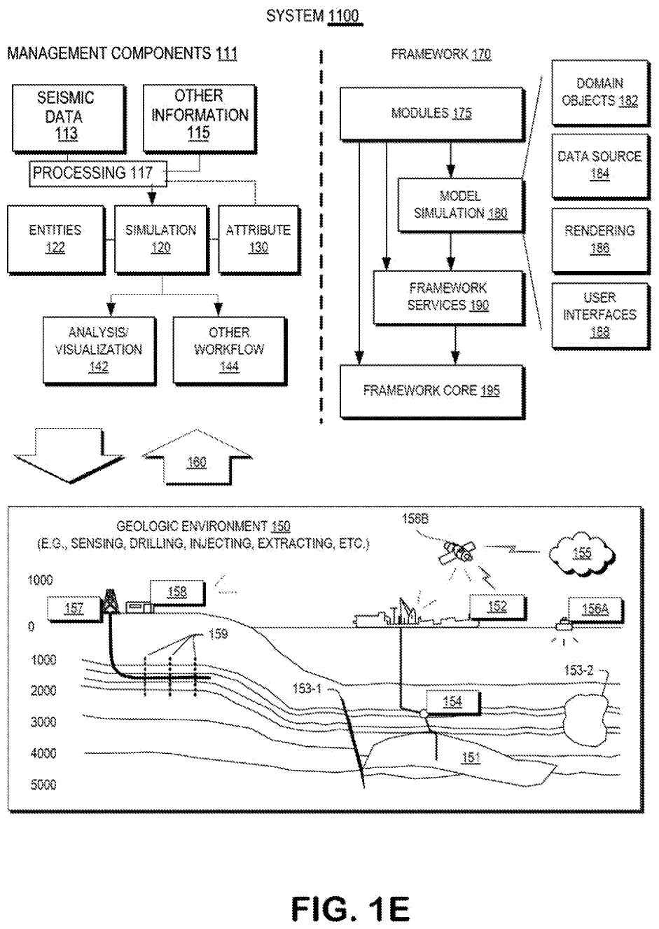

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

FIG. 1E illustrates an example of a system 1100 that includes various management components 111 to manage various aspects of a geologic environment 150 (e.g., an environment that includes a sedimentary basin, a reservoir 151, one or more faults 153-1, one or more geobodies 153-2, etc.). For example, the management components 111 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1E, the management components 111 include a seismic data component 113, an additional information component 115 (e.g., well/logging data), a processing component 117, a simulation component 120, an attribute component 130, an analysis/visualization component 142 and a workflow component 144. In operation, seismic data and other information provided per the components 113 and 115 may be input to the simulation component 120.

In some embodiments, the simulation component 120 may rely on entities 122. Entities 122 may include earth entities or geological objects such as wells, surfaces, bodies, reservoirs, etc. In the system 1100, the entities 122 can include virtual representations of actual physical entities that are reconstructed for purposes of simulation. The entities 122 may include entities based on data acquired via sensing, observation, etc. (e.g., the seismic data 113 and other information 115). An entity may be characterized by one or more properties (e.g., a geometrical pillar grid entity of an earth model may be characterized by a porosity property). Such properties may represent one or more measurements (e.g., acquired data), calculations, etc.

In some embodiments, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1E, the simulation component 120 may process information to conform to one or more attributes specified by the attribute component 130, which may include a library of attributes. Such processing may occur prior to input to the simulation component 120 (e.g., consider the processing component 117). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1E, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE® reservoir simulator (Schlumberger Limited, Houston Texas), the INTERSECT® reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In some embodiments, the management components 111 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 111 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1E also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1E, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1E, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1E, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1E shows a satellite in communication with the network 155 that may be configured for communications, noting that the satellite may additionally or instead include circuitry for imagery (e.g., spatial, spectral, temporal, radiometric, etc.).

FIG. 1E also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 1100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

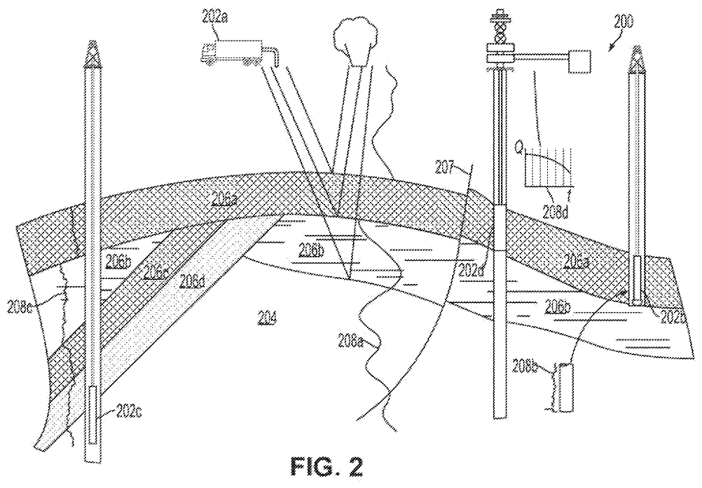

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d , respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

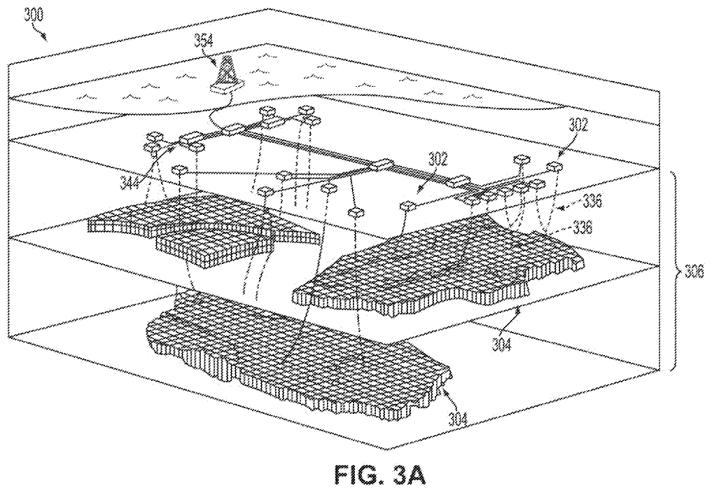

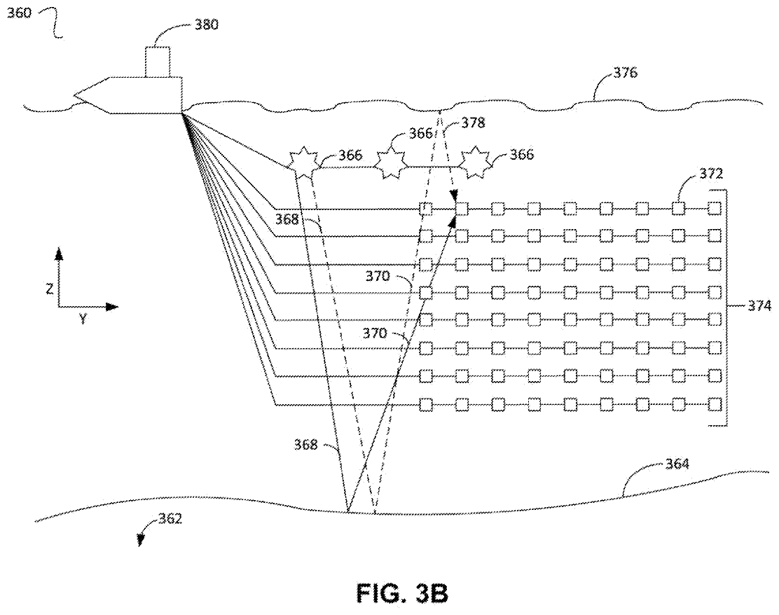

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### Acquisition Constrained Compressive Sensing Design for OBN Surveys

Crossline sampling related artifacts in seismic data acquisition can present a challenge because the coarser sampling along crossline can create aliasing, resulting in poor quality data processing and imaging. One way to circumvent this is to use CS-based acquisition design, which provides denser sampling for a similar cost to conventional surveys. CS, a rank-minimization based optimization strategy for survey design, can be used to evaluate the optimal source-receiver layout. An optimal survey design exhibits small spectral ratio (SR), which is the ratio of the first to second singular values. As the ratio becomes smaller, the underlying design has a larger spectral gap, which means that the underlying sampling design exhibits maximum randomization in the transform domain. Survey design is constrained by the movement of sources and receivers, and the speed of the vessels in the field. Moreover, sources and/or receiver separation is generally a static variable while acquiring the seismic data in the field, and thus generally cannot be reconfigured.

Embodiments of the present disclosure address these challenges and others by acquisition constrained random sampling design for an OBN survey, which exploits the benefits of CS-based survey design while staying in the practical boundaries of the acquisition system. For example, source vessels can move in wavy, curved, or, e.g., sinusoidal patterns instead of straight lines while acquiring the seismic data. Such patterns are thus feasible in practice and enhance the randomness of the sampling, while acquiring the data with the conventional acquisition systems. Further, embodiments may include reconstructing seismic data using the periodic and acquisition constrained CS design. The reconstruction quality of the design, compared with the standard periodic sampling, demonstrates that the randomness introduced by the acquisition design in accordance with embodiments of the present disclosure enhances the quality of the interpolation.

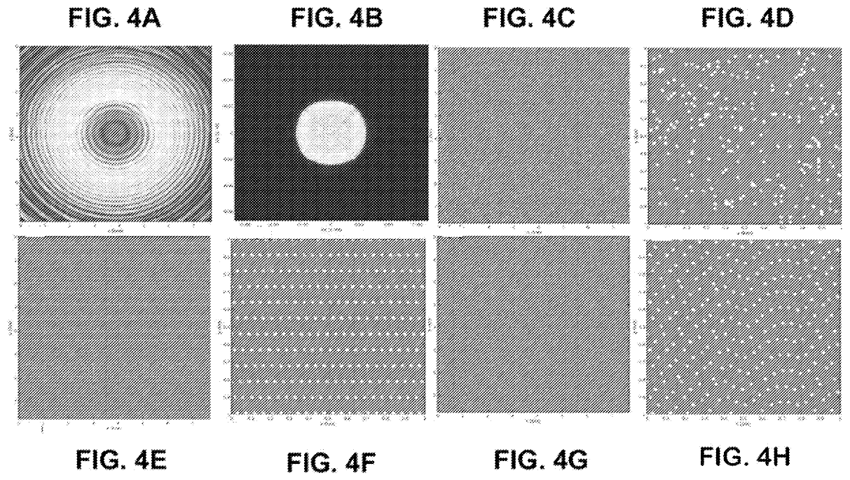

FIGS. 4A-H illustrate different sub-sampling scenarios for an OBN survey. In particular, FIGS. 4A and 4B illustrate a frequency slice at 20 hertz (Hz) and the corresponding wavenumber spectrum. FIG. 4C illustrates jittered sampling design, which is one type of constrained CS sampling scenario. FIG. 4E illustrates periodic sampling design, which is another type of constraint used for OBN surveys. FIGS. 4D, 4F, and 4H show zoomed-in sections extracted from the top left corner of FIGS. 4C, 4E, and 4G, respectively.

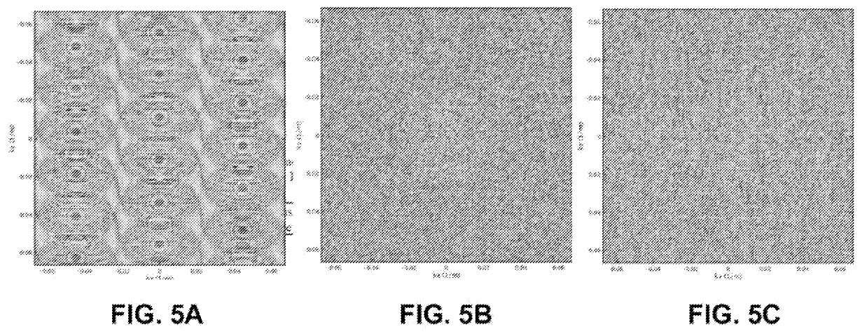

FIGS. 5A-C illustrate the effect of different subsampling scenarios on the frequency-wavenumber spectrum, according to an embodiment. More particularly, FIG. 5A illustrates periodic sampling design, which can create aliasing on top of the true events. FIG. 5B illustrates a CS-based jittered sampling scenario that turns aliasing into noise, thus converting an interpolation problem into a simpler denoising problem. FIG. 5C illustrates an acquisition constrained random design, which incorporates the benefits of CS into an OBN survey without making large changes in an existing seismic field operation system.

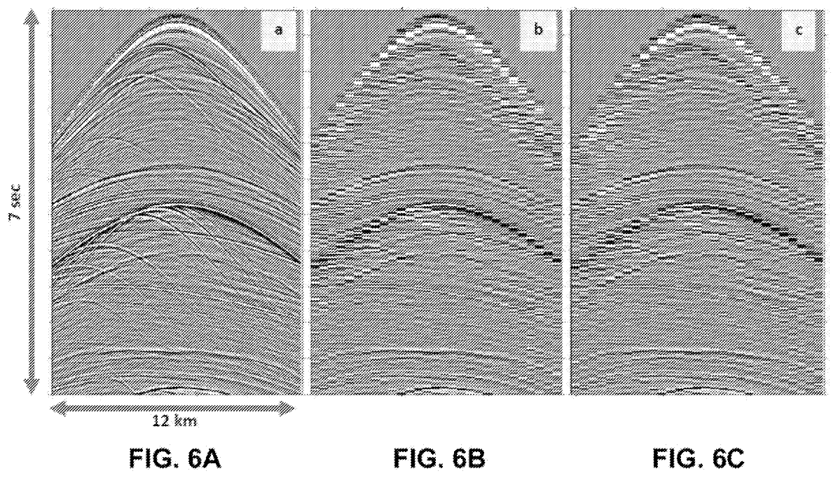

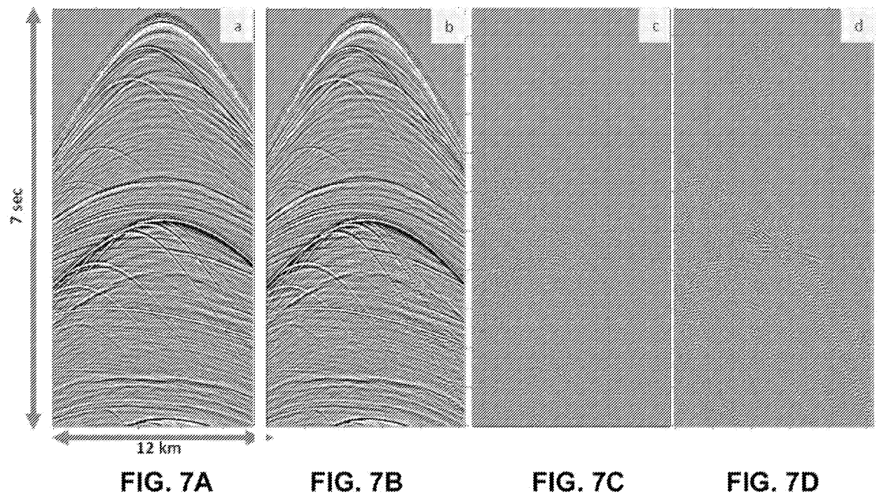

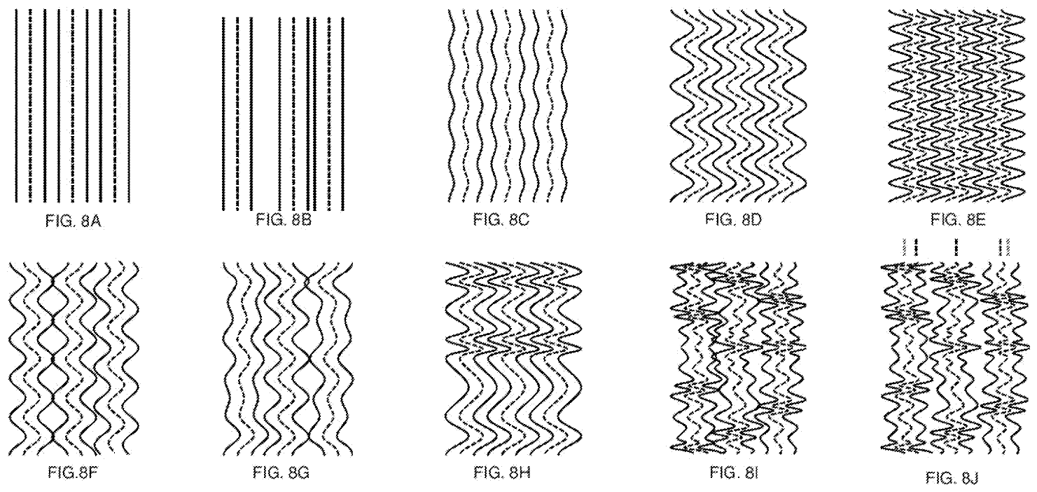

FIGS. 6A-C illustrate a common receiver gather extracted from a geologically complex SEAM model. More particularly, FIG. 6A illustrates a cross-line section extracted from fully sampled data. FIG. 6B illustrates periodically sampled data extracted from the crossline section. FIG. 6C illustrates subsampled data using an embodiment of the acquisition method disclosed herein.

FIGS. 7A-D illustrate reconstruction results. More particularly, FIG. 7A illustrates reconstruction results from a CS-based acquisition design. FIG. 7B illustrates reconstruction results from a periodic subsampling. FIGS. 7C and 7D illustrate a difference between FIGS. 7A and 7B with respect to FIG. 6A. It will be appreciated that the CS-based acquisition design can reconstruct complex diffraction energy and the reflection energy buried beneath the diffraction events.

To understand the benefits of an acquisition constrained random sampling scenario for seismic data acquisition, three subsampling scenarios are considered for an OBN acquisition, namely periodic, jittered, and acquisition constrained random subsampling scenarios. To demonstrate the effect of subsampling on acquisition design, a frequency slice at 20 Hz (FIG. 4A) may be extracted from synthetic data simulated on a complex geological SEAM model. The aim is to interpolate the data on a 15 m grid along the inline and crossline direction, whereas the data acquired in the field, are on 50 m and 100 m grids. FIG. 4B shows the wavenumber spectrum of the fully sampled data. In the example in FIGS. 4A and 4B, the number of samples is fixed for the different acquisition scenarios.

One approach to data acquisition in the OBN is periodic sub-sampling where air guns on a single or multiple vessels are fired in a periodic fashion. Periodic sub-sampling can include processing such as data interpolation of the seismic data after acquisition because periodic sub-sampling can create aliasing events in the frequency-wavenumber of the data, which overlay the true events. While performing the interpolation, it is possible that the interpolation framework may pick an aliased event. FIG. 4E shows the periodic sub-sampling design and FIG. 5A shows the corresponding wavenumber spectrum. It can be seen that it is not always possible to remove aliasing artifacts (FIG. 5A) because true and aliased events may not be distinguishable from one another.

Another approach to data acquisition in the OBN is jittered sub-sampling. According to compressed sensing (CS) based acquisition design, the sampling should destroy the structure of the underlying fully sampled data in a transform domain to enable successful acquired data reconstruction. Random sub-sampling can create gaps in the data, and jittered sub-sampling can control the average amount of information per row in the transform domain. FIG. 4C illustrates a jittered sub-sampling pattern, and FIG. 5B shows the wavenumber spectrum of a frequency slice sub-sampled using the jittered sub-sampling pattern. By using jittered sub-sampling, aliases become noise and are removed by conventional (or otherwise) denoising.

To mitigate the bottleneck of periodic sub-sampling and exploiting the benefits of CS-based sampling design, embodiments in accordance with the present disclosure include acquisition constrained random sub-sampling design. Such methods may create randomness in the acquisition system with relatively small changes to the field operation. For the example, interpolating data from 50 m×100 m grid to 15 m×15 m grid along the inline and cross-line direction, allows perturbing sources within ±22.5 m along inline direction and ±50 m along the cross-line direction.

To design a sine wave-driven seismic survey under the acquisition constraint of the fixed in space multi-sources on each vessel, the following non-convex combinatorial optimization problem for off-the-grid subsampling mask M∈{0,1}ⁿ^{ₛ}ⁿ^{ᵣ} is solved:

$$φ ( M ) = {minimize}_{M} \frac{{σ}_{2} ( {𝒯𝒩}^{′} M )}{{σ}_{1} ( {𝒯𝒩}^{′} M )}$$

subject to

$${‖ M ‖}_{0} = ⌊ {n}_{s} \times r ⌋ x ⌊ {n}_{r} \times r ⌋ ⋂ M ∈ ( 𝒥 + 𝒟 ∈ {\{ - {a}_{1} , {a}_{2} \}}^{{n}_{s} {n}_{r}} + ε ∈ {\{ - {p}_{1} , {p}_{2} \}}^{{n}_{s} {n}_{r}} + γ ∈ {\{ - {c}_{1} , {c}_{1} \}}^{{n}_{s} {n}_{r}} ) ⋂ M ∈ {\{ 0 , 1 \}}^{{n}_{s} \times {n}_{r}} . \qquad ( 1 )$$

In Equation (1), σ represents the singular value of the underlying mask M in the transform domain ( [symbol] ) where the data exhibit sparse or low-rank structure, [symbol] ∈ [symbol] ⁿ^{ₛₓ}ⁿ^{_{sy}}ⁿ^{ᵣₓ}ⁿ^{_{ry}} ^{x n}^{_{sub}} NE [symbol] ⁿ^{ₛₓ}ⁿ^{_{sy}}ⁿ^{ᵣₓ}ⁿ^{_{ry}} ^{x n}^{_{sub}} represents a multidimensional off-the-grid Fourier transform which maps data from an unstructured sub-sampling grid to a dense periodic grid, and └ . . . ┘ denotes a rounding operation. An off-the-grid Fourier transform is used because the spectral ratio of the underlying grid does not change if evaluated in a physical domain or a Fourier domain, since the Fourier transform conserves energy and is orthogonal in nature. Constraints are imposed while solving Equation (1) to find optimal unstructured grid locations. The first constraint, i.e., └nₛx r┘x└nᵣx r┘, ensures that the outcome of the optimization problem maintains a desired sub-sampling ratio r. The second constraint includes at least one spatial sampling parameter. For example, (i) jittered sampling is defined to control the gap size between the source-receiver locations during the survey designing process, and/or (ii) the amplitude of the sine-wave pattern [symbol] incorporates crossline movement of vessels by ±a from the underlying periodic grid, and/or (iii) the phase of the sine-wave pattern [symbol] 0 incorporates inline movement of vessel by −p from the underlying periodic grid, which controls how slow or fast the vessel is acquiring data in the inline direction, thus resulting in dense or sparse inline sampling, and/or (iv) an overlap factor γ controls if the crosslines overlap with each other or not during the acquisition. Note that both amplitude and phase could be a constant number across the source line or could be selected from a range constrained by the acquisition design.

FIG. 4G illustrates an acquisition constrained random sampling design for an OBN survey and FIG. 5C shows the corresponding wavenumber spectrum. The CS design results in a wavy sinusoidal source pattern over the survey area, where the amplitude and wavelength of the sinusoidal wave controls the randomness in the acquisition design. In some configurations, if a vessel contains multiple source arrays, then the perturbation direction of source arrays along a crossline is consistent, i.e., if one source array moves +20.5 m in crossline direction, other sources move with the same perturbation. Such a constraint may ensure that no changes are made to the field operation system. Further, it can be seen that the acquisition constrained random sampling turns aliasing (FIG. 5A) into random noise (FIG. 5C), thus achieving the benefits of CS-based survey design.

Referring now to FIGS. 8A-8J, examples of survey patterns that can be used in accordance with embodiments of the present disclosure are shown. These patterns results from varying the phase and amplitude of the exemplary sine wave survey pattern. Other patterns and modifications can be used, the sine wave is merely exemplary. FIG. 8A illustrates a straight line survey pattern, which FIG. 8B illustrates a random shift in the cross-line pattern. FIG. 8C illustrates a sine wave pattern, FIG. 8D illustrates a sine wave pattern with an amplitude increase, and FIG. 8E illustrates a sine wave pattern with a period decrease. FIG. 8F illustrates a sine wave with a phase shift, FIG. 8G illustrates a sine wave with variable amplitude, and FIG. 8H illustrates a sine wave with variable period. FIG. 8I illustrates a sine wave with a combination of perturbations, and FIG. 8J illustrates a sine wave with a combination of perturbations in addition to a crossline separation extended. Many other options are possible.

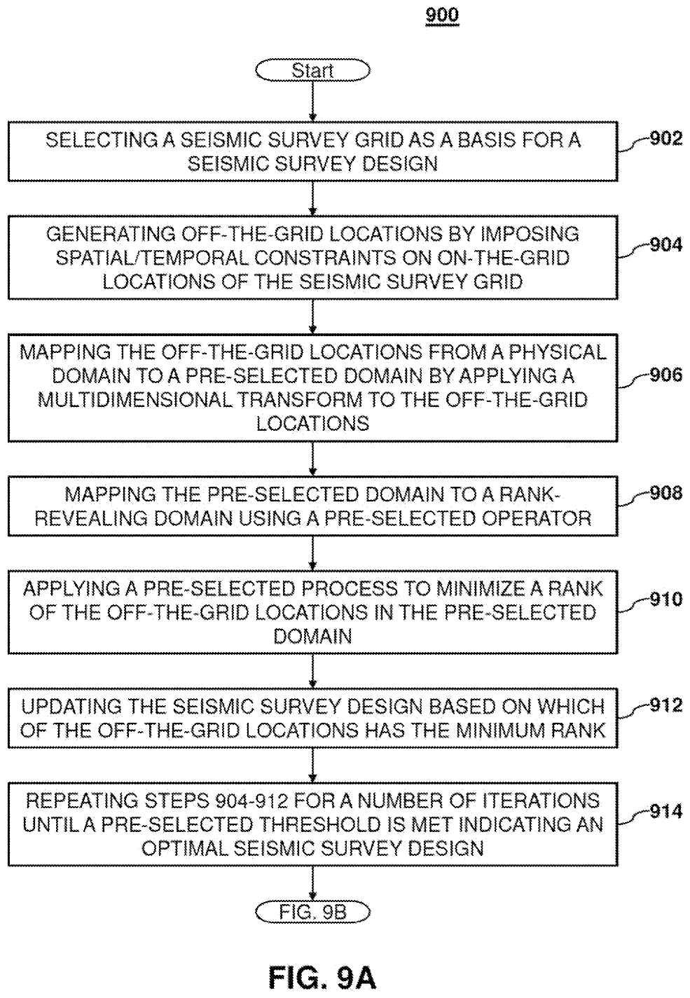

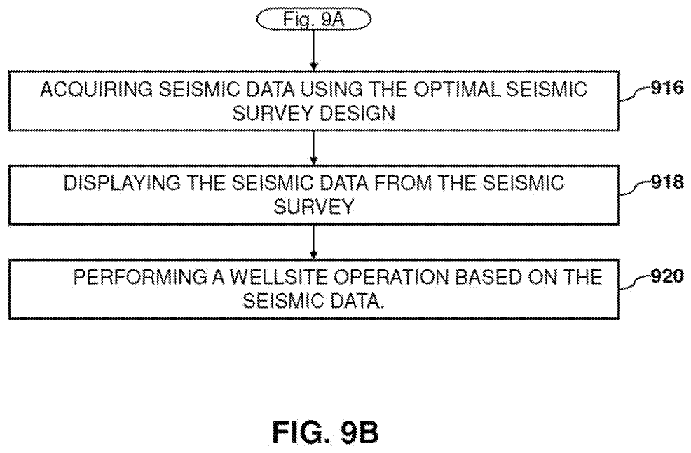

Referring now to FIGS. 9A and 9B, a method 900 for designing a seismic survey in accordance with embodiments of the present disclosure can include, but is not limited to including, selecting 902 (FIG. 9A) a seismic survey grid as a basis for a seismic survey design, generating 904 (FIG. 9A) off-the-grid locations by imposing spatial/temporal constraints on on-the-grid locations of the seismic survey grid, and mapping 906 (FIG. 9A) the off-the-grid locations from a physical domain to a pre-selected domain by applying a multidimensional transform to the off-the-grid locations. The method 900 includes mapping 908 (FIG. 9A) the pre-selected domain to a rank-revealing domain using a pre-selected operator, applying 910 (FIG. 9A) a pre-selected process to minimize a rank of the off-the-grid locations in the pre-selected domain, and updating 912 (FIG. 9A) the seismic survey design based on which of the off-the-grid locations has the minimum rank. The method 900 includes repeating 914 (FIG. 9A) steps 904-912 (FIG. 9A) for a number of iterations until a pre-selected threshold is met indicating an optimal seismic survey design, acquiring 916 (FIG. 9B) seismic data using the optimal seismic survey design, displaying 918 (FIG. 9B) the seismic data from the seismic survey, and performing 920 (FIG. 9B) a wellsite operation based on the seismic data. The wellsite operation may be based upon the seismic data from the seismic survey. The wellsite operation may be or include generating and/or transmitting a signal (e.g., using a computing system) that causes a physical action to occur at a wellsite. The wellsite operation may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

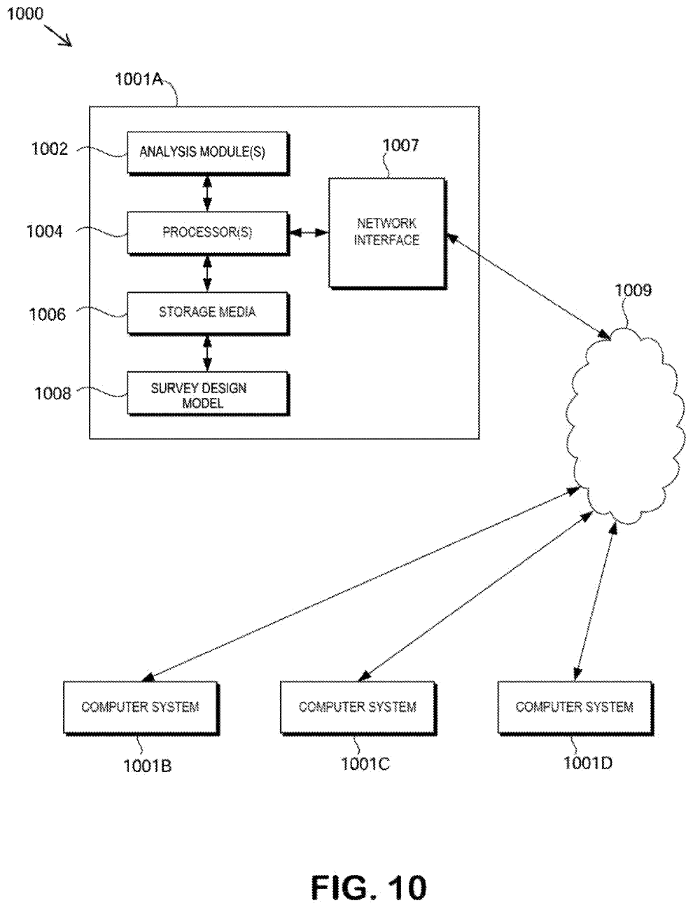

In some embodiments, any of the methods of the present disclosure may be executed using a system, such as a computing system. FIG. 10 illustrates an example of such a computing system 1000, in accordance with some embodiments. The computing system 1000 may include a computer or computer system 1001a, which may be an individual computer system 1001a or an arrangement of distributed computer systems. The computer system 1001a includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001a to communicate over a data network 1009 with one or more additional computer systems and/or computing systems, such as 1001b, 1001c, and/or 1001d (note that computer systems 1001b, 1001c and/or 1001d may or may not share the same architecture as computer system 1001a, and may be located in different physical locations, e.g., computer systems 1001a and 1001b may be located in a processing facility, while in communication with one or more computer systems such as 1001c and/or 1001d that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001a, in some embodiments, storage media 1006 may be distributed within and/or across multiple internal and/or external enclosures of computing system 1001a and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more survey design module(s) 1008. In the example of computing system 1000, computer system 1001a includes the survey design module 1008. In some embodiments, a single survey design module may be used to perform some or all aspects of one or more embodiments of the methods. In alternate embodiments, a plurality of survey design modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general-purpose processors or application specific chips, such as ASICs, FPGAs, PLDs, or other appropriate devices. These modules, combinations of these modules, and/or their combination with general hardware are all included within the scope of protection of embodiments of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

1. A method for designing a seismic survey, the method comprising:
selecting a seismic survey grid as a basis for a seismic survey design;
generating off-the-grid locations by imposing spatial/temporal constraints on on-the-grid locations of the seismic survey grid, wherein the spatial/temporal constraints for a source activation process include a quiet time between source activations, and wherein the quiet time includes setting a cap on a minimum or maximum randomized time interval between consecutive shots;
mapping the off-the-grid locations from a physical domain to a pre-selected domain by applying a multidimensional transform to the off-the-grid locations;
applying a pre-selected process to minimize a rank of the off-the-grid locations in the pre-selected domain; and
updating the seismic survey design based on which of the off-the-grid locations has the minimum rank.

2. The method as in claim 1, wherein the spatial/temporal constraints include a range of pre-selected offsets from the on-the-grid locations, the off-the-grid locations configured to collect ocean bottom node (OBN) sparse data.

3. The method as in claim 1, wherein a first constraint of the spatial/temporal constraints ensures that the off-the-grid locations maintain a desired sub-sampling ratio, and a second constraint of the spatial/temporal constraints is a spatial sub-sampling parameter.

4. The method as in claim 3, wherein the spatial sub-sampling parameter is a jittered sampling parameter to control a gap size between source-receiver locations.

5. The method as in claim 3, wherein the spatial sampling parameter is an overlap factor that controls if crosslines of a seismic survey overlap with each other or not during data acquisition.

6. The method as in claim 3, wherein the spatial sub-sampling parameter is a first characteristic of a pre-selected survey pattern that incorporates crossline movement of vessels by a first pre-selected amount from the seismic survey grid.

7. The method as in claim 6, wherein the first characteristic is an amplitude of a sine wave pattern.

8. The method as in claim 7, wherein the spatial sub-sampling parameter is a second characteristic of the pre-selected survey pattern that incorporates inline movement of the vessels by a second pre-selected amount from the seismic survey grid.

9. The method as in claim 8, wherein the second characteristic is a phase of the sine wave pattern.

10. The method as in claim 1, wherein the pre-selected domain is a wavenumber domain or a sparsity promoting domain.

11. The method as in claim 10, wherein the multidimensional transform is a Fourier transform when the pre-selected domain is the wavenumber domain.

12. The method as in claim 1, wherein the pre-selected process includes:
mapping the pre-selected domain to a rank-revealing domain using a pre-selected operator;
computing first and second singular values from the rank-revealing domain; and
estimating a spectral ratio as a ratio of the first and second singular values.

13. The method as in claim 1, wherein the number of iterations is based on a heuristic process.

14. The method as in claim 1, wherein:
seismic data are acquired from a regular or irregular grid with random time or space dithers, the regular or irregular grid having a seismic source,
multiple seismic sources are activated in activation patterns that are extended to more than two of the seismic sources,
the seismic sources are deployed in a marine environment as single seismic sources or multiple seismic sources from single vessel-or multiple vessel-configurations for marine environments and used to acquire the seismic data,
the optimal seismic survey design includes regular or irregular grid locations with time dithers using an optimization scheme for both of the seismic sources and seismic receivers in a pre-selected number of directions,
the seismic sources are activated together or separated in time along with random and/or periodic time dithers with respect to each other, and
the optimal seismic survey design enables acquiring simultaneous and sequential seismic data.

15. The method as in claim 14, wherein the rank minimization is constrained by ensuring that two of the seismic sources are not activated within a pre-selected distance from each other by using spatial location constraints.

16. The method as in claim 14, wherein:
the seismic receivers are deployed in water along towed streamers or within waterbottom nodes, or the seismic receivers are geophones deployed on land, or the seismic receivers are deployed in wells,
the seismic data from the seismic receivers are obtained through distributed acoustic sensors using fiber optics cables, and
the seismic data include measurements of one or more of pressure, particle velocity, displacement, or acceleration wavefields or any subset of these.

17. (canceled)

18. A computing system comprising at least one processor, at least one memory, and one or more programs stored in the at least one memory, wherein the programs comprise instructions, which when executed by the at least one processor, are configured to perform a method comprising:
(a) selecting a seismic survey grid as a basis for a seismic survey design;
(b) generating off-the-grid locations by imposing spatial or temporal constraints on on-the-grid locations of the seismic survey grid, wherein the spatial or temporal constraints include a range of pre-selected offsets from the on-the-grid locations, the off-the-grid locations configured to collect ocean bottom node (OBN) sparse data,
wherein a first constraint ensures that the off-the-grid locations maintain a desired sub-sampling ratio, and a second constraint is a spatial sub-sampling parameter, wherein the spatial sub-sampling parameter is a jittered sampling parameter to control a gap size between source-receiver locations, and/or the spatial sub-sampling parameter is a first characteristic of a pre-selected survey pattern that incorporates crossline movement of vessels by a first pre-selected amount from the seismic survey grid, wherein the first characteristic is an amplitude of a sine wave pattern, and/or the spatial sub-sampling parameter is a second characteristic of the pre-selected survey pattern that incorporates inline movement of the vessel by a second pre-selected amount from the seismic survey grid, wherein the second characteristic is a phase of the sine wave pattern, and/or the spatial sampling parameter is an overlap factor that controls if crosslines of the seismic survey overlap with each other or not during data acquisition;
(c) mapping the off-the-grid locations from a physical domain to a pre-selected domain by applying a multidimensional transform to the off-the-grid locations;
(d) mapping the pre-selected domain to a rank-revealing domain using a pre-selected operator;
(e) applying a pre-selected process to minimize a rank of the off-the-grid locations in the pre-selected domain, wherein the pre-selected process includes:
(1) computing first and second singular values from the rank-revealing domain; and
(2) estimating a spectral ratio as a ratio of the first and second singular values;
(f) updating the seismic survey design based on which of the off-the-grid locations has the minimum rank; and
(g) repeating steps (b)-(f) for a number of iterations until a pre-selected threshold is met indicating an optimal seismic survey design, wherein the number of iterations is based on a heuristic process.

19. The computing system as in claim 18, wherein the pre-selected domain is a wavenumber domain or a sparsity promoting domain, and wherein the multidimensional transform is a Fourier transform when the pre-selected domain is the wavenumber domain.

20. A non-transitory computer-readable medium storing instructions that, when executed by one or more processors of a computing system, cause the computing system to perform operations, the operations comprising:
(a) selecting a seismic survey grid as a basis for a seismic survey design;
(b) generating off-the-grid locations by imposing spatial or temporal constraints on on-the-grid locations of the seismic survey grid, wherein the spatial or temporal constraints include a range of pre-selected offsets from the on-the-grid locations, the off-the-grid locations configured to collect ocean bottom node (OBN) sparse data,
wherein a first constraint ensures that the off-the-grid locations maintain a desired sub-sampling ratio, and a second constraint is a spatial sub-sampling parameter,
wherein the spatial sub-sampling parameter is a jittered sampling parameter to control a gap size between source-receiver locations, and/or the spatial sub-sampling parameter is a first characteristic of a pre-selected survey pattern that incorporates crossline movement of vessels by a first pre-selected amount from the seismic survey grid, wherein the first characteristic is an amplitude of a sine wave pattern, and/or the spatial sub-sampling parameter is a second characteristic of the pre-selected survey pattern that incorporates inline movement of the vessel by a second pre-selected amount from the seismic survey grid, wherein the second characteristic is a phase of the sine wave pattern, and/or the spatial sampling parameter is an overlap factor that controls if crosslines of the seismic survey overlap with each other or not during data acquisition;
(c) mapping the off-the-grid locations from a physical domain to a pre-selected domain by applying a multidimensional transform to the off-the-grid locations, wherein the pre-selected domain is a wavenumber domain or a sparsity promoting domain, and wherein the multidimensional transform is a Fourier transform when the pre-selected domain is the wavenumber domain;
(d) mapping the pre-selected domain to a rank-revealing domain using a pre-selected operator;
(e) applying a pre-selected process to minimize a rank of the off-the-grid locations in the pre-selected domain, wherein the pre-selected process includes:
(1) computing first and second singular values from the rank-revealing domain; and
(2) estimating a spectral ratio as a ratio of the first and second singular values;
(f) updating the seismic survey design based on which of the off-the-grid locations has the minimum rank;
(g) repeating steps (b)-(f) for a number of iterations until a pre-selected threshold is met indicating an optimal seismic survey design, wherein the number of iterations is based on a heuristic process;
(h) acquiring seismic data using the optimal seismic survey design, wherein:
the seismic data are acquired from a regular or irregular grid with random time or space dithers, the regular or irregular grid having a seismic source,
multiple seismic sources are activated in activation patterns that are extended to more than two of the seismic sources,
the seismic sources are deployed in a marine environment as single seismic sources or multiple seismic sources from single vessel-or multiple vessel-configurations for marine environments and used to acquire the seismic data,
the rank minimization is constrained by ensuring that two of the seismic sources are not activated within a pre-selected distance from each other by using spatial location constraints,
the optimal seismic survey design includes regular or irregular grid locations with time dithers using an optimization scheme for both of the seismic sources and seismic receivers in a pre-selected number of directions,
the seismic receivers are deployed in water along towed streamers or within waterbottom nodes, or the seismic receivers are geophones deployed on land, or the seismic receivers are deployed in wells,
the seismic data from the seismic receivers are obtained through distributed acoustic sensors using fiber optics cables,
the seismic sources are activated together or separated in time along with random and/or periodic time dithers with respect to each other,
the optimal seismic survey design enables acquiring simultaneous and sequential seismic data,
the spatial or temporal constraints for a source activation process include a quiet time between source activations, wherein the quiet time includes setting a cap on a minimum or maximum randomized time interval between consecutive shots, and
the seismic data include measurements of one or more of pressure, particle velocity, displacement, or acceleration wavefields or any subset of these;
(j) enabling processing and displaying the seismic data from the seismic survey; and
(k) enabling performing a wellsite action based at least on the seismic data.
